(19) United States
(12) Patent Application Publication
(10) Pub. No.: US 2018/0238190 A1
(43) Pub. Date: Aug. 23, 2018

(54) NOZZLE DRIVE MECHANISM AND TURBOCHARGER

(71) Applicant: IHI Corporation, Koto-ku (JP)

(72) Inventors: Kengo IKEDA, Tokyo (JP); Yoshimitsu MATSUYAMA, Tokyo (JP); Toshifumi TERUI, Tokyo (JP); Munehiro YOSHIDA, Tokyo (JP)

(73) Assignee: IHI Corporation, Koto-ku (JP)

(21) Appl. No.: 15/962,144

(22) Filed: Apr. 25, 2018

Related U.S. Application Data
(63) Continuation of application No. PCT/JP2016/078562, filed on Sep. 28, 2016.

(30) Foreign Application Priority Data
Oct. 26, 2015 (JP) 2015-209829

(51) Int. Cl. F01D 17/16; F02B 37/24

(52) U.S. Cl. CPC F01D 17/16; F05D 2220/40; F02B 37/24

(57) ABSTRACT

Provided is a nozzle drive mechanism, including: a bearing; a drive shaft inserted into a bearing hole; and a link plate having an opposing portion, which is opposed to at least the bearing in an axial direction of the drive shaft, and is subjected to hardening treatment, the link plate being fixed to the drive shaft by caulking, bolt-fastening, or press-fitting.

### CROSS REFERENCE TO RELATED APPLICATIONS

This application is a continuation application of International Application No. PCT/JP2016/078562, filed on Sep. 28, 2016, which claims priority to Japanese Patent Application No. 2015-209829, filed on Oct. 26, 2015, the entire contents of which are incorporated by reference herein.

### BACKGROUND ART

### Technical Field

The present disclosure relates to a nozzle drive mechanism in which a bearing having a drive shaft inserted thereinto is opposed to a link plate, and a turbocharger.

### Related Art

Hitherto, a turbocharger of a variable capacity type has been widely used. In such a turbocharger, for example, as disclosed in Patent Literature 1, a plurality of nozzle vanes are annularly arrayed in a flow passage for introducing exhaust gas from a turbine scroll flow passage to a turbine impeller. The nozzle vanes are fixed to blade shafts. When the blade shafts are rotated by power of an actuator, the nozzle vanes are displaced in the flow passage along with the rotation of the blade shafts. When the nozzle vanes are displaced, a flow passage width is changed. In such a manner, a flow rate of the exhaust gas flowing through the flow passage is controlled.

Further, a link plate is arranged on a power transmission path from the actuator to the blade shafts. The link plate is welded to a drive shaft. The drive shaft is inserted into a bearing hole of an annular bush (bearing).

When the drive shaft is rotated by the power of the actuator, the link plate swings. Then, the plurality of nozzle vanes are displaced through a drive ring and the like.

### CITATION LIST

### Patent Literature

Patent Literature 1: Japanese Patent No. 5737161 B2

### SUMMARY

### Technical Problem

The link plate described above is opposed to the bearing in an axial direction of the drive shaft. Therefore, when the link plate receives pressure of the exhaust gas introduced to the turbine impeller side, the link plate is pressed toward the bearing side in some cases. At this time, when the link plate swings in a state of being held in abutment against the bearing at an opposing portion with respect to the bearing, there is a fear in that the opposing portion is abraded depending on, for example, an operating condition of an engine to which a turbocharger is mounted.

Therefore, it is an object of the present disclosure to provide a nozzle drive mechanism and a turbocharger, which are capable of improving durability against abrasion.

### Solution to Problem

In order to achieve the above problem, according to one embodiment of the present disclosure, there is provided a nozzle drive mechanism, including: a bearing; a drive shaft inserted into the bearing; and a link plate having an opposing portion, which is opposed to at least the bearing in an axial direction of the drive shaft, and is subjected to hardening treatment, the link plate being fixed to the drive shaft by caulking, bolt-fastening, or press-fitting.

The nozzle drive mechanism may include: an insertion hole, which is formed in the link plate, and is configured to receive the drive shaft to be inserted into the insertion hole; and an insertion portion to be inserted into the insertion hole, which is formed at a distal end portion of the drive shaft, and is caulked at a part of the insertion portion projecting from the insertion hole.

The drive shaft may be subjected to the hardening treatment at a portion other than the insertion portion.

The drive shaft may include: a large-diameter portion which has an outer diameter larger than an outer diameter of the insertion portion; and a step surface, which extends in a radial direction of the drive shaft from an outer peripheral surface of the insertion portion to an outer peripheral surface of the large-diameter portion, and is opposed to the link plate in an axial direction of the drive shaft.

The link plate may be entirely subjected to the hardening treatment.

In order to achieve the above problem, a turbocharger according to one embodiment of the present disclosure includes the above-mentioned nozzle drive mechanism.

### EFFECTS OF DISCLOSURE

According to the present disclosure, the durability against abrasion can be improved.

### BRIEF DESCRIPTION OF DRAWINGS

FIG. 1 is a schematic sectional view of a turbocharger.

FIG. 2A is an extraction view of the broken line portion on an upper side in FIG. 1.

FIG. 2B is an extraction view of the one-dot chain line portion on a lower side in FIG. 1.

FIG. 3 is a plan view of a support ring.

FIG. 4 is a view for illustrating a state in which a drive ring is supported by the support ring.

FIG. 5A is a first explanatory view for illustrating mounting of a drive shaft to a link plate.

FIG. 5B is a second explanatory view for illustrating mounting of the drive shaft to the link plate.

FIG. 5C is a third explanatory view for illustrating mounting of the drive shaft to the link plate.

FIG. 5D is a view for illustrating a state in which the drive shaft is inserted into a bearing after mounting of the drive shaft to the link plate.

### DESCRIPTION OF EMBODIMENT

Now, with reference to the attached drawings, an embodiment of the present disclosure is described in detail. The dimensions, materials, and other specific numerical values represented in the embodiment are merely examples used for facilitating the understanding, and do not limit the present disclosure otherwise particularly noted. Elements having substantially the same functions and configurations herein and in the drawings are denoted by the same reference symbols to omit redundant description thereof. Further, illustration of elements with no direct relationship to the present disclosure is omitted.

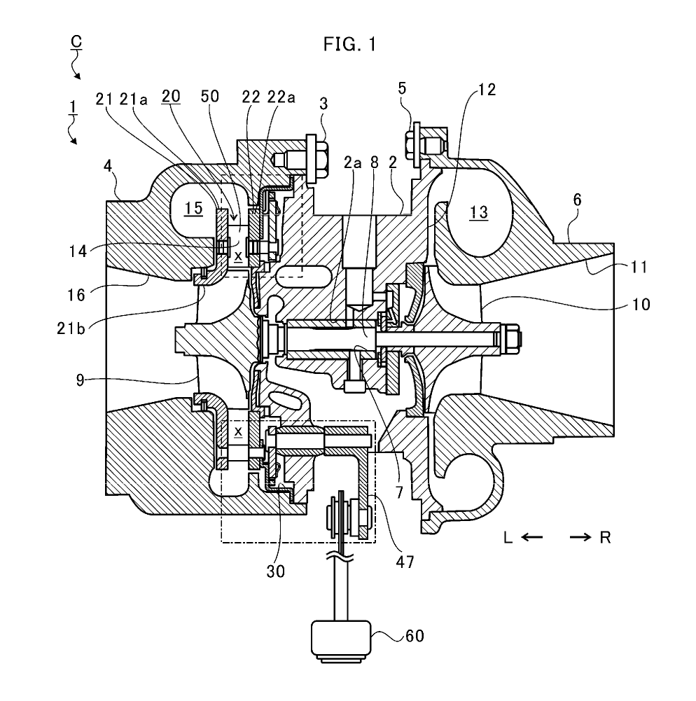

FIG. 1 is a schematic sectional view of a turbocharger C. In the following description, the direction indicated by the arrow L illustrated in FIG. 1 corresponds to a left side of the turbocharger C. The direction indicated by the arrow R illustrated in FIG. 1 corresponds to a right side of the turbocharger C. As illustrated in FIG. 1, the turbocharger C includes a turbocharger main body 1. The turbocharger main body 1 includes a bearing housing 2. A turbine housing 4 is coupled to the left side of the bearing housing 2 by a fastening bolt 3. A compressor housing 6 is coupled to the right side of the bearing housing 2 by a fastening bolt 5. The bearing housing 2, the turbine housing 4, and the compressor housing 6 are integrated.

The bearing housing 2 has a receiving hole 2a. The receiving hole 2a penetrates through the turbocharger C in a right-and-left direction. A semi-floating bearing 7 is received in the receiving hole 2a. A shaft 8 is axially supported by the semi-floating bearing 7 (example of a radial bearing) so as to be rotatable. A turbine impeller 9 is provided to a left end portion of the shaft 8. The turbine impeller 9 is received in the turbine housing 4 so as to be rotatable. Further, a compressor impeller 10 is provided to a right end portion of the shaft 8. The compressor impeller 10 is received in the compressor housing 6 so as to be rotatable.

The compressor housing 6 has an intake port 11. The intake port 11 is opened on the right side of the turbocharger C. An air cleaner (not shown) is connected to the intake port 11. Further, under a state in which the bearing housing 2 and the compressor housing 6 are coupled to each other by the fastening bolt 5 as described above, a diffuser flow passage 12 is formed. The diffuser flow passage 12 is formed by opposed surfaces of the bearing housing 2 and the compressor housing 6. The diffuser flow passage 12 increases pressure of air. The diffuser flow passage 12 is annularly formed so as to extend from a radially inner side to a radially outer side of the shaft 8. The diffuser flow passage 12 communicates with the intake port 11 via the compressor impeller 10 on the inner side in the radial direction.

Further, the compressor housing 6 has a compressor scroll flow passage 13. The compressor scroll flow passage 13 has an annular shape. The compressor scroll flow passage 13 is positioned on the radially outer side of the shaft 8 with respect to the diffuser flow passage 12. The compressor scroll flow passage 13 communicates with an intake port of an engine (not shown). The compressor scroll flow passage 13 communicates also with the diffuser flow passage 12. Thus, when the compressor impeller 10 is rotated, air is sucked into the compressor housing 6 through the intake port 11. The sucked air is increased in speed and pressure during a course of flowing through blades of the compressor impeller 10. The air increased in speed and pressure is increased in pressure (pressure recovery) in the diffuser flow passage 12 and the compressor scroll flow passage 13. The air increased in pressure is introduced to the engine.

Further, under a state in which the bearing housing 2 and the turbine housing 4 are coupled to each other by the fastening bolt 3, a gap 14 is formed. The gap 14 is formed between opposed surfaces of the bearing housing 2 and the turbine housing 4. Nozzle vanes 50, which are described later, are arranged in the gap 14. The gap 14 is a space forming a flow passage “x”. The flow passage “x” allows exhaust gas to flow therethrough. The gap 14 is annularly formed so as to extend from a radially inner side of the shaft 8 (turbine impeller 9) toward an outer side.

Further, the turbine housing 4 has a discharge port 16. The discharge port 16 communicates with the turbine scroll flow passage 15 through the turbine impeller 9. The discharge port 16 faces a front side of the turbine impeller 9. The discharge port 16 is connected to an exhaust gas purification device (not shown).

The turbine scroll flow passage 15 communicates with a gas inflow port (not shown). Exhaust gas discharged from the engine is introduced to the gas inflow port. The turbine scroll flow passage 15 communicates also with the flow passage “x” described above. Thus, the exhaust gas introduced through the gas inflow port to the turbine scroll flow passage 15 is introduced to the discharge port 16 through the flow passage “x” and the turbine impeller 9. That is, the flow passage “x” is a passage which extends from the turbine scroll flow passage 15 to the turbine impeller 9. The exhaust gas introduced to the discharge port 16 causes the turbine impeller 9 to rotate during a course of flowing. Then, a rotational force of the turbine impeller 9 described above is transmitted to the compressor impeller 10 through the shaft 8. In the manner described above, the air is increased in pressure by the rotational force of the compressor impeller 10, and is introduced to the intake port of the engine.

At this time, when the flow rate of the exhaust gas introduced to the turbine housing 4 changes, the rotation amounts of the turbine impeller 9 and the compressor impeller 10 change. In some cases, depending on an operating condition of the engine, the air increased in pressure to a desired pressure is not sufficiently introduced to the intake port of the engine. In view of the above-mentioned circumstance, a nozzle drive mechanism 20 is provided to the turbocharger C. The nozzle drive mechanism 20 changes a flow passage width of the flow passage “x” of the turbine housing 4.

The nozzle drive mechanism 20 changes the flow speed of the exhaust gas introduced to the turbine impeller 9 in accordance with a flow rate of the exhaust gas. Specifically, when the rotation speed of the engine is low, and the flow rate of the exhaust gas is small, the nozzle drive mechanism 20 decreases a degree of opening of the flow passage “x”. In such a manner, the nozzle drive mechanism 20 increases the flow speed of the exhaust gas introduced to the turbine impeller 9. In this case, the turbine impeller 9 can be rotated even with a small flow rate. Now, description is made of a configuration of the nozzle drive mechanism 20.

The nozzle drive mechanism 20 includes a shroud ring 21 and a nozzle ring 22. The shroud ring 21 is provided on the turbine housing 4 side. The nozzle ring 22 is provided on the bearing housing 2 side so as to be opposed to the shroud ring 21. The flow passage “x” is defined (formed) by the shroud ring 21 and the nozzle ring 22.

The shroud ring 21 includes a main body portion 21a. The main body portion 21a has a thin-plate ring shape. A projecting portion 21b is formed at an inner peripheral edge of the main body portion 21a. The projecting portion 21b projects toward the discharge port 16 side. The nozzle ring 22 includes a main body portion 22a. The main body portion 22a has a thin-plate ring shape. The main body portion 22a has a diameter which is equal to a diameter of the main body portion 21a of the shroud ring 21. The main body portion 22a is opposed to the shroud ring 21 while maintaining a predetermined interval.

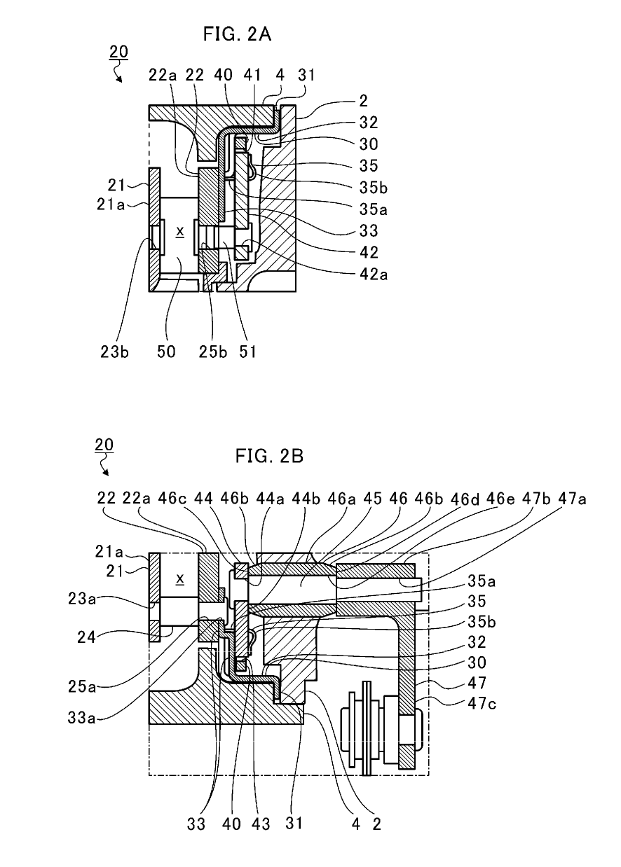

FIG. 2A is an extraction view of a broken line portion on an upper side in FIG. 1. FIG. 2B is an extraction view of a one-dot chain line portion on a lower side in FIG. 1. As illustrated in FIG. 2B, a pin shaft hole 23a is formed in the main body portion 21a of the shroud ring 21. The pin shaft hole 23a penetrates through the main body portion 21a in a thickness direction (axial direction of the shaft 8). A plurality of (three in this embodiment, but only one in FIG. 2B) pin shaft holes 23a are formed at equal intervals in a circumferential direction.

Further, a pin shaft hole 25a is formed in the main body portion 22a of the nozzle ring 22. The pin shaft hole 25a penetrates through the main body portion 22a in a thickness direction (axial direction of the shaft 8). A plurality of (three in this embodiment, but only one in FIG. 2B) pin shaft holes 25a are formed at equal intervals in a circumferential direction. The pin shaft hole 23a formed in the shroud ring 21 and the pin shaft hole 25a formed in the nozzle ring 22 are opposed to each other. A coupling pin 24 is inserted into each of the pin shaft holes 23a and 25a.

Specifically, as illustrated in FIG. 2B, one end of the coupling pin 24 is inserted into the pin shaft hole 25a of the nozzle ring 22. Another end of the coupling pin 24 is inserted into the pin shaft hole 23a of the shroud ring 21. A plurality of (three in this embodiment, but only one in FIG. 2B) coupling pins 24 are arrayed at equal intervals in a circumferential direction. The coupling pin 24 maintains a constant interval between the nozzle ring 22 and the shroud ring 21 opposed to each other.

Further, the one end of the coupling pin 24 which is inserted into the pin shaft hole 25a of the nozzle ring 22 projects toward the right side from the nozzle ring 22. This projecting part is caulked so that the support ring 30 is fixed on the right side of the nozzle ring 22. The support ring 30 is formed of a cylindrical member. The support ring 30 has a sectional shape obtained by bending a member having a thin-plate shape (see FIG. 1).

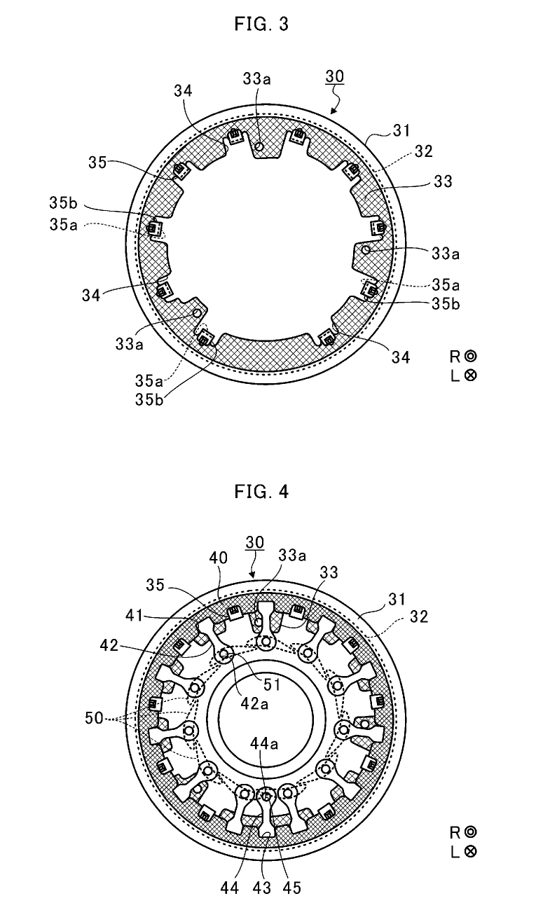

FIG. 3 is a plan view of the support ring 30. The near side in the drawing sheet of FIG. 3 is oriented toward the right side in FIG. 2A and FIG. 2B. The far side in the drawing sheet of FIG. 3 is oriented toward the left side in FIG. 2A and FIG. 2B. As illustrated in FIG. 2A and FIG. 2B, the support ring 30 includes a flange portion 31, a cylindrical portion 32, and a bottom portion 33 (indicated by cross-hatching in FIG. 3). The flange portion 31 has an annular shape. The cylindrical portion 32 stands toward the left side (far side in FIG. 3) from the inner peripheral edge of the flange portion 31. The bottom portion 33 is bent toward the radially inner side from a left end portion of the cylindrical portion 32.

As illustrated in FIG. 2A and FIG. 2B, under a state in which the flange portion 31 is sandwiched between opposed surfaces of the bearing housing 2 and the turbine housing 4, the bearing housing 2 and the turbine housing 4 are fastened by the fastening bolt 3. In such a manner, the support ring 30 is retained in the turbine housing 4.

As illustrated in FIG. 3, the bottom portion 33 has ring holes 33a. The ring holes 33a are each capable of receiving one end of the above-mentioned coupling pin 24 inserted thereinto. The ring holes 33a are formed at three locations at equal intervals in a circumferential direction. The coupling pin 24 is inserted into the ring hole 33a and then caulked. In such a manner, the support ring 30, the shroud ring 21, and the nozzle ring 22 are integrated.

Further, the bottom portion 33 has a plurality of recessed portions 34 arrayed in the circumferential direction.

The recessed portions 34 are each formed by being cut out from an end portion of the bottom portion 33 on an inner periphery side toward the radially outer side. Support pieces 35 are provided to the recessed portions 34, respectively. The support pieces 35 each include a support portion 35a and a removal prevention portion 35b. The support portion 35a is bent toward the right side (near side in FIG. 3) from the bottom portion 33. The removal prevention portion 35b is bent toward the radially outer side from the support portion 35a. The removal prevention portion 35b faces the bottom portion 33. The removal prevention portion 35b is arranged apart from the bottom portion 33 by a predetermined distance. The drive ring 40 is supported by the support piece 35 (see FIG. 4) so as to be rotatable. For example, the nozzle drive mechanism 20 may include a ring member other than the support ring 30, and the support pieces 35 may be provided to this ring member. In this case, for example, the ring member is arranged at an outermost portion adjacent to the support ring 30 on the drive ring 40 side. The ring member is caulked similarly to the support ring 30, the shroud ring 21, and the nozzle ring 22 to be integrated with the support ring 30, the shroud ring 21, and the nozzle ring 22.

FIG. 4 is a view for illustrating a state in which the drive ring 40 is supported by the support ring 30. In FIG. 4, for easy understanding, the bottom portion 33 of the support ring 30 is indicated by cross-hatching. In FIG. 4, the drive ring 40 is indicated by cross-hatching finer than that of the bottom portion 33.

The drive ring 40 is formed of an annular thin-plate member. An inner peripheral edge of the drive ring 40 is supported by the support pieces 35 of the support ring 30 so as to be rotatable. As illustrated in FIG. 2A and FIG. 4, the drive ring 40 has a plurality of first engagement recess portions 41 arrayed in the circumferential direction. The first engagement recess portions 41 are each formed by being cut out from an end portion of the drive ring 40 on an inner periphery side toward the radially outer side. One ends of transmission links 42 are engaged with the first engagement recess portions 41.

Further, as illustrated in FIG. 2B and FIG. 4, one second engagement recess portion 43 is formed at the end portion of the drive ring 40 on the inner periphery side. The second engagement recess portion 43 has the same shape as the engagement recess portion 41. One end of a link plate 44 having the same shape as the transmission link 42 is engaged with the second engagement recess portion 43.

A fitting hole 42a is formed on another end side of each transmission link 42. An insertion hole 44a is formed on another end side of the link plate 44. As illustrated in FIG. 2A, a blade shaft 51 fixed to the nozzle vane 50 is inserted into the fitting hole 42a and fixed thereat. As illustrated in FIG. 2B, the drive shaft 45 is fitted to the insertion hole 44a of the link plate 44.

The blade shaft 51 is inserted into blade shaft holes 23b and 25b, and is axially supported so as to be rotatable. The blade shaft hole 23b is formed on the radially inner side with respect to the above-mentioned pin shaft hole 23a in the main body portion 21a of the shroud ring 21. The blade shaft hole 23b penetrates through the main body portion 21a in the thickness direction (axial direction of the shaft 8). A plurality of (eleven in this embodiment, but only one in FIG. 2A) blade shaft holes 23b are formed at equal intervals in the circumferential direction of the main body portion 21a. The blade shaft holes 23b formed in the shroud ring 21 on a side opposite to the nozzle ring 22 over the nozzle vanes 50 may be omitted. In this case, the blade shafts 51 are inserted only into the blade holes 25b formed in the nozzle ring 22 described later, and are axially supported so as to be rotatable (in a cantilever state).

Similarly, the blade shaft hole 25b is formed on the radially inner side with respect to the above-mentioned pin shaft hole 25a in the main body portion 22a of the nozzle ring 22. The blade shaft hole 25b penetrates through the main body portion 22a in the thickness direction (axial direction of the shaft 8). A plurality of (eleven in this embodiment, but only one in FIG. 2A) blade shaft holes 25b are formed at equal intervals in the circumferential direction of the main body portion 22a. The blade shaft holes 23b formed in the shroud ring 21 and the blade shaft holes 25b formed in the nozzle ring 22 are opposed to each other.

One end of the blade shaft 51 which is inserted into the blade shaft hole 25b of the nozzle ring 22 projects toward the right side from the nozzle ring 22. The one end of the blade shaft 51 is inserted into the fitting hole 42a of the transmission link 42. The projecting part at one end of the blade shaft 51 is caulked. In such a manner, the transmission link 42 is fixed to the blade shaft 51.

In such a manner, the blade shafts 51 and the nozzle vanes 50 are arranged in the flow passage “x” described above. The plurality of the blade shafts 51 are annularly arrayed apart from each other in the rotation direction of the turbine impeller 9. The plurality of the nozzle vanes 50 are annularly arrayed apart from each other in the rotation direction of the turbine impeller 9. As illustrated in FIG. 2B, the drive shaft 45 extends toward the right side from the drive ring 40. The extending portion of the drive shaft 45 is inserted into a bearing 46. In detail, the bearing 46 has an annular main body portion 46a. The main body portion 46a has tapered surfaces 46b. The tapered surfaces 46b are formed in an outer peripheral surface of the main body portion 46a on both end (end surface 46c and end surface 46d) sides in a center axis direction of the main body portion 46a. The tapered surfaces 46b have outer diameters which increase from the end surface 46c and the end surface 46d toward a center in the center axis direction of the main body portion 46a. An inner peripheral surface of the bearing hole 46e of the main body portion 46a serves as a bearing surface. The drive shaft 45 is inserted into the bearing hole 46e.

Further, a drive lever 47 is coupled to another end of the drive shaft 45. An actuator 60 is provided outside a housing of the turbocharger C (see FIG. 1). The drive lever 47 is coupled to the actuator 60. Specifically, the drive lever 47 is formed of, for example, a tubular portion 47b and a flat-plate portion 47c. The tubular portion 47b has an insertion hole 47a. The drive shaft 45 is inserted into the insertion hole 47a. The flat-plate portion 47c continues from the tubular portion 47b and extends to the radially outer side. The flat-plate portion 47c is coupled to the actuator 60. The drive lever 47 has a substantially L-shape in section including a center of the drive shaft 45. When the actuator 60 drives the drive lever 47, as illustrated in FIG. 2B, the drive lever 47 and the drive shaft 45 swing (rotate) about an axial center of the drive shaft 45 as a rotation center. The rotation power from the actuator 60 is transmitted to the link plate 44, thereby causing the link plate 44 to swing.

The second engagement recess portion 43 is pressed by the link plate 44 illustrated in FIG. 4. In such a manner, the drive ring 40 rotates. When the drive ring 40 rotates, the transmission links 42 connected respectively to the plurality of first engagement recess portions 41 are pressed by the rotation of the drive ring 40. The transmission links 42 swing. Along with the swinging of the transmission links 42, the plurality of blade shafts 51 rotate. Along with the rotation of the blade shafts 51, the plurality of nozzle vanes 50 integrally (in conjunction) change respective angles in the flow passage “x”. In such a manner, the nozzle drive mechanism 20 causes the link plate 44 to swing by the power of the actuator 60. Then, the nozzle drive mechanism 20 displaces the plurality of nozzle vanes 50. The nozzle drive mechanism 20 is capable of changing the width of the flow passage “x”.

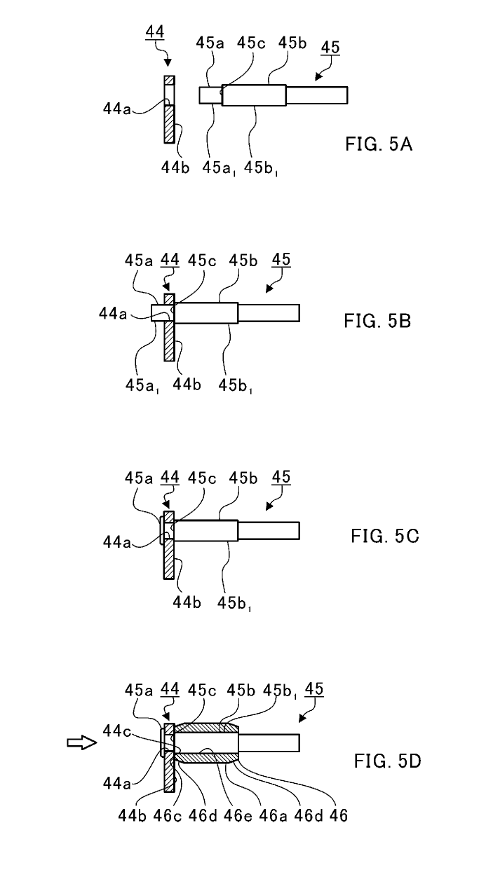

FIG. 5A is a first explanatory view for illustrating mounting of the drive shaft 45 to the link plate 44. FIG. 5B is a second explanatory view for illustrating mounting of the drive shaft 45 to the link plate 44. FIG. 5C is a third explanatory view for illustrating mounting of the drive shaft 45 to the link plate 44. FIG. 5D is a view for illustrating a state in which the drive shaft 45 is inserted into the bearing 46 after mounting of the drive shaft 45 to the link plate 44. As illustrated in FIG. 5A, an insertion portion 45a is formed at a distal end portion of the drive shaft 45. The insertion portion 45a is inserted into the insertion hole 44a of the link plate 44. Further, a large-diameter portion 45b is a part of the drive shaft 45. The large-diameter portion 45b is formed on a center side (side opposite to the link plate 44) of the drive shaft 45 with respect to the insertion portion 45a. The large-diameter portion 45b has an outer diameter larger than that of the insertion portion 45a. A step surface 45c is formed by a difference in outer diameter between the insertion portion 45a and the large-diameter portion 45b. The step surface 45c extends in a radial direction of the drive shaft 45. The step surface 45c is a surface connecting the insertion portion 45a and the large-diameter portion 45b to each other. The step surface 45c extends from an outer peripheral surface 45a₁ of the insertion portion 45a to an outer peripheral surface 45b₁ of the large-diameter portion 45b. For example, the step surface 45c is a surface orthogonal to the axial direction of the drive shaft 45. In the step surface 45c, a curved surface, for example, a chamfered shape or a round shape may be formed at a corner portion that continues to the insertion portion 45a and the large-diameter portion 45b.

Hitherto, welding has been employed as a method of fixing the link plate 44 and the drive shaft 45 to each other. Herein, caulking is employed. Now, description is made of a method of fixing the link plate 44 and the drive shaft 45 to each other.

As illustrated in FIG. 5B, the insertion portion 45a of the drive shaft 45 is inserted into the insertion hole 44a of the link plate 44. An outer diameter of the insertion portion 45a of the drive shaft 45 is slightly larger than an inner diameter of the insertion hole 44a of the link plate 44. The insertion portion 45a is press-fitted to the insertion hole 44a.

When the drive shaft 45 is inserted (press-fitted) into the insertion hole 44a as described above, a surface 44b of the link plate 44 on the right side in FIG. 5B and the step surface 45c are opposed to each other in the axial direction of the drive shaft 45. Then, when the surface 44b of the link plate 44 and the step surface 45c of the drive shaft 45 are brought into abutment against each other, one end of the drive shaft 45 projects from the insertion hole 44a of the link plate 44. As described above, positioning of the drive shaft 45 with respect to the link plate 44 in the insertion direction is performed with the step surface 45c.

Next, as illustrated in FIG. 5C, a part of the insertion portion 45a of the drive shaft 45 on one end side projecting from the insertion hole 44a is squeezed. In such a manner, the link plate 44 and the drive shaft 45 are fixed to each other (caulking). After that, as illustrated in FIG. 5D, the drive shaft 45 is inserted into the bearing hole 46e of the bearing 46.

Incidentally, the link plate 44 is opposed to the bearing 46 in the axial direction of the drive shaft 45. In some cases, for example, the link plate 44 receives pressure of exhaust gas introduced to the turbine impeller 9 side, with the result that the link plate 44 is pressed toward the bearing 46 as indicated by the outlined arrow in FIG. 5D. At this time, an opposing portion 44c of the surface 44b of the link plate 44 is brought into abutment against the bearing 46. The opposing portion 44c is a part of the surface 44b of the link plate 44 which is opposed to the bearing 46 in the axial direction of the drive shaft 45. The opposing portion 44c is brought into abutment against an end surface 46c of the bearing 46 on the link plate 44 side. Under a state in which the end surface 46c of the bearing 46 and the opposing portion 44c are held in abutment against each other, the link plate 44 having received power transmitted from the actuator 60 swings. As a result, for example, depending on an operating condition of an engine to which the turbocharger C is mounted, there is a fear in that the opposing portion 44c is abraded due to contact with the end surface 46c of the bearing 46.

In view of the above-mentioned circumstance, for example, the link plate 44 is entirely subjected to nitriding treatment being hardening treatment. The link plate 44 is made of metal such as stainless steel. The surface of the link plate 44 is subjected to the nitriding treatment being the hardening treatment. However, the hardening treatment is not limited to the nitriding treatment. For example, there may be employed other treatment for increasing hardness, such as carburizing treatment or chromizing treatment (chromium diffusing treatment).

In a case in which the link plate 44 and the drive shaft 45 are to be fixed to each other by welding, when the link plate 44 is subjected to the hardening treatment, a component of a material used for the hardening treatment may be mixed into the welded portion as impurities. Therefore, there is difficulty in stably performing welding. In this embodiment, welding is not employed as a method of fixing the link plate 44 and the drive shaft 45 to each other. Through employment of caulking as a method of fixing the link plate 44 and the drive shaft 45 to each other, the link plate 44 can be stably subjected to the hardening treatment. As a result, the durability of the link plate 44 against abrasion can be improved.

Further, not only the link plate 44 but also the drive shaft 45 may be subjected to the hardening treatment. In this case, for example, a portion of the drive shaft 45 other than the insertion portion 45a is subjected to the hardening treatment. The insertion portion 45a is plastically deformed during caulking, that is, a course of squeezing by imparting a load on a part of the insertion portion 45a on one end side projecting from the insertion hole 44a. When the insertion portion 45a is to be subjected to the hardening treatment, it is required to finely manage the magnitude of the load, the speed of imparting the load, or the like during caulking, so as to prevent the occurrence of cracks during plastic deformation. When the portion of the drive shaft 45 other than the insertion portion 45a is subjected to the hardening treatment, degradation in operability of caulking is suppressed. As a result, the abrasion resistance of the drive shaft 45 can be improved.

The embodiment of the present disclosure has been described above with reference to the attached drawings, but, needless to say, the present disclosure is not limited to the embodiment. It is apparent that those skilled in the art may arrive at various alternations and modifications within the scope of claims, and those examples are construed as naturally falling within the technical scope of the present disclosure.

For example, in the above-mentioned embodiment, description is made of the case of employing caulking as a method of fixing the link plate 44 and the drive shaft 45 to each other. However, the link plate 44 and the drive shaft 45 may be assembled to each other by bolt-fastening or press-fitting. Further, in the case of employing caulking, the number of components can be reduced. In the case of employing caulking, the link plate 44 and the drive shaft 45 can reliably be fixed to each other.

Further, in the above-mentioned embodiment, description is made of the case in which the drive shaft 45 has the step surface 45c, and the link plate 44 and the step surface 45c are opposed to each other. However, the step surface 45c is not always required. When the step surface 45c is formed, positioning of the insertion portion 45a in the insertion direction is performed, thereby improving accuracy in positioning. Further, the step surface 45c serves as a fixing surface in the case of employing the method of fixing by caulking. Therefore, when the step surface 45c is formed, wobbling of the link plate 44 and the drive shaft 45 is suppressed.

Further, in the above-mentioned embodiment, description is made of the case in which the insertion portion 45a of the drive shaft 45 is press-fitted to the insertion hole 44a of the link plate 44. However, the insertion portion 45a of the drive shaft 45 may be simply inserted, rather than being press-fitted, into the insertion hole 44a of the link plate 44. Further, in the case in which the insertion portion 45a of the drive shaft 45 is press-fitted to the insertion hole 44a of the link plate 44, when the caulking is performed, the link plate 44 and the drive shaft 45 are fixed to each other more reliably. In addition, wobbling is suppressed. Further, the sectional shape of each of the insertion portion 45a of the drive shaft 45 and the insertion hole 44a of the link plate 44 along a direction orthogonal to the axial direction is not limited to a circular shape. As long as the insertion portion 45a and the insertion hole 44a have a corresponding shape, the sectional shape along a direction orthogonal to the axial direction may be, for example, a polygonal shape such as a rectangular shape. Further, the sectional shape along a direction orthogonal to the axial direction may be, for example, a substantially oval shape. The substantially oval shape may include, for example, a shape which is formed by cutting out opposed outer peripheral portions of a circular shape and having two opposed straight portions being substantially parallel to each other (width-across-flat portion). In these cases, positioning of the drive shaft 45 in the rotation direction (circumferential direction) of the drive shaft 45 can be performed with the sectional shape. When the insertion portion 45a of the drive shaft 45 is inserted into the insertion hole 44a of the link plate 44, the link plate 44 is easily arranged at an expected position in the circumferential direction about the axial center of the drive shaft 45.

Further, in the above-mentioned embodiment, description is made of the case in which the link plate 44 is entirely subjected to the hardening treatment. However, it is only necessary that at least the opposing portion 44c of the link plate 44 be subjected to the hardening treatment. Further, for example, when only the opposing portion 44c is subjected the hardening treatment, there arises need for masking on portions excluding the opposing portion 44c. Therefore, the burden of working increases. When the link plate 44 is entirely subjected to the hardening treatment, degradation in ease of working is suppressed. Further, the abrasion resistance of the link plate 44 can be improved.

Further, in the above-mentioned embodiment, description is made of the case in which a portion of the drive shaft 45 other than the insertion portion 45a is subjected to the hardening treatment. However, it is not always necessary that the drive shaft 45 be subjected to the hardening treatment. The insertion portion 45a may be subjected to the hardening treatment. The large-diameter portion 45b of the drive shaft 45 may be subjected to the hardening treatment, and a coating agent for improving the slidability may be sprayed on the large-diameter portion 45b after the hardening treatment. A coating for improving the slidability is formed on the large-diameter portion 45b after the hardening treatment. In this case, the reliability of power transmission from the drive shaft 45 to the link plate 44 can be improved.

Further, as mentioned above, in the case of employing caulking as a method of fixing the link plate 44 and the drive shaft 45 to each other, when the caulking is performed before the drive lever 47 is fixed to the drive shaft 45, the drive shaft 45 can be easily handled. The working can be easily performed. Therefore, the drive shaft 45 is inserted into the bearing 46 fixed to the bearing housing 2. It is conceivable to fix the drive lever 47 and the drive shaft 45 to each other after performing caulking of the link plate 44 and the drive shaft 45. In this case, for example, an opening portion which penetrates through the outer peripheral surface of the tubular portion 47b of the drive lever 47 to the insertion hole 47a is formed. Then, welding is performed from the radially outer side of the opening portion. The drive lever 47 may be fixed to the drive shaft 45 in such a manner. It is assumed that, a space formed between the end surface of the drive shaft 45 on the drive lever 47 side and, for example, the flange portion on the compressor housing 6 side in the bearing housing 2 is limited from the mounting condition on the engine. Even in such a case, through formation of the above-mentioned opening portion, welding can easily be performed.

### INDUSTRIAL APPLICABILITY

The present disclosure can be used for a nozzle drive mechanism in which a bearing having a drive shaft inserted thereinto is opposed to a link plate, and a turbocharger.

What is claimed is:

1. A nozzle drive mechanism, comprising:
a bearing;
a drive shaft inserted into the bearing; and
a link plate having an opposing portion, which is opposed to at least the bearing in an axial direction of the drive shaft, and is subjected to hardening treatment, the link plate being fixed to the drive shaft by caulking, bolt-fastening, or press-fitting.

2. A nozzle drive mechanism according to claim 1, further comprising:
an insertion hole, which is formed in the link plate, and is configured to receive the drive shaft to be inserted into the insertion hole; and
an insertion portion to be inserted into the insertion hole, which is formed at a distal end portion of the drive shaft, and is caulked at a part of the insertion portion projecting from the insertion hole.

3. A nozzle drive mechanism according to claim 2, wherein the drive shaft is subjected to the hardening treatment at a portion other than the insertion portion.

4. A nozzle drive mechanism according to claim 2, wherein the drive shaft comprises:
a large-diameter portion which has an outer diameter larger than an outer diameter of the insertion portion; and
a step surface, which extends in a radial direction of the drive shaft from an outer peripheral surface of the insertion portion to an outer peripheral surface of the large-diameter portion, and is opposed to the link plate in an axial direction of the drive shaft.

5. A nozzle drive mechanism according to claim 3, wherein the drive shaft includes:
a large-diameter portion which has an outer diameter larger than an outer diameter of the insertion portion; and
a step surface, which extends in a radial direction of the drive shaft from an outer peripheral surface of the insertion portion to an outer peripheral surface of the large-diameter portion, and is opposed to the link plate in an axial direction of the drive shaft.

6. A nozzle drive mechanism according to claim 1, wherein the link plate is entirely subjected to the hardening treatment.

7. A nozzle drive mechanism according to claim 2, wherein the link plate is entirely subjected to the hardening treatment.

8. A nozzle drive mechanism according to claim 3, wherein the link plate is entirely subjected to the hardening treatment.

9. A nozzle drive mechanism according to claim 4, wherein the link plate is entirely subjected to the hardening treatment.

10. A nozzle drive mechanism according to claim 5, wherein the link plate is entirely subjected to the hardening treatment.

11. A turbocharger, comprising the nozzle drive mechanism of claim 1.

12. A turbocharger, comprising the nozzle drive mechanism of claim 2.

13. A turbocharger, comprising the nozzle drive mechanism of claim 3.

14. A turbocharger, comprising the nozzle drive mechanism of claim 4.

15. A turbocharger, comprising the nozzle drive mechanism of claim 5.

16. A turbocharger, comprising the nozzle drive mechanism of claim 6.

17. A turbocharger, comprising the nozzle drive mechanism of claim 7.

18. A turbocharger, comprising the nozzle drive mechanism of claim 8.

19. A turbocharger, comprising the nozzle drive mechanism of claim 9.

20. A turbocharger, comprising the nozzle drive mechanism of claim 10.
